(19) United States
(12) Patent Application Publication
(10) Pub. No.: US 2002/0116710 A1
(43) Pub. Date: Aug. 22, 2002

(54) Television viewer profile initializer and related methods

(76) Inventors: James David Schaffer, Wappingers Falls, NY (US); Paul John Rankin, Surrey (GB); Keith Mathias, Parker, CO (US); John Milanski, Boulder, CO (US)

Correspondence Address: Corporate Patent Counsel, Philips Electronics North America Corporation, 580 White Plains Road, Tarrytown, NY, 10591, US

(21) Appl. No.: 09/791,999

(22) Filed: Feb. 22, 2001

(51) Int. Cl. H04N 7/16; H04H 9/00; H04N 7/025; H04N 7/10; G06F 3/00; H04N 5/445; G06F 13/00

(52) U.S. Cl. 725/46; 725/9; 725/35

(57) ABSTRACT

A TV viewer profile initializer for reducing the time it takes for an implicit profiler-based TV recommender to produce accurate TV recommendations. The profiles initializer utilizes stereotype profiles from a substantial pool of TV viewing behavior of a representative number of TV viewers. By applying clustering methods to such data, stereotype profiles can emerge. New viewers are then be offered a selection of stereotype profiles to choose from to initialize their own personal TV viewing profile. Thus, a single choice will suffice to provide a predictable TV show recommender that is presumably fairly close to a viewer's own preferences. After this initialization, the profile can be adapted by the user's own viewing behavior to migrate from the initial stereotype towards a more accurate profile of the user.

### FIELD OF THE INVENTION

This invention relates to television (TV) recommenders, and more particularly to a TV viewer profile initializer for reducing the time it takes for an implicit profiler-based TV recommender to produce accurate TV recommendations.

### BACKGROUND OF THE INVENTION

The large selection of TV channels available today has spawn the creation of TV show recommenders. TV show recommenders are typically used with conventional broadcast TV to recommend TV shows based on a viewer's personal TV viewer profile. TV recommenders are also featured in most personal television (PTV) services. PTV services enable viewers to view programs at anytime, independent of when the networks choose to show them. This is typically accomplished by providing viewers with Personal TV Recorders which are essentially set top boxes equipped with hard-drives. The PTV service, which includes TV recommender software, is loaded on the hard-drives, thus, enabling the set top boxes to selectively record and playback live television broadcasts in accordance with the viewer's personal TV viewer profile.

The TV viewing profiles are currently derived using three basic methods: implicit profiling; explicit profiling; and feedback profiling. Implicit profiling methods derive TV viewing profiles from the viewer's television viewing histories, i.e., sets of TV shows watched and not watched. Explicit profiling methods derive TV viewing profiles from viewer answered questionnaires that include explicit questions about what the viewer likes and dislikes. Feedback profiling methods derive TV viewing profiles from sets of TV shows for which a viewer has provided ratings of the degree of like or dislike.

Explicit and feedback profiling methods, however, can require onerous amounts of effort from the viewer. Implicit profiling methods on the other hand require little or no explicit action by the viewer. Unfortunately, they can take a long time before they can produce good recommendations.

Accordingly, a method is needed that reduces the time it takes for an implicit profiler-based TV recommender to produce accurate TV recommendations.

### SUMMARY OF THE INVENTION

One aspect of the present invention involves a method of initializing a recommender user's personal behavior profile. The method comprises collecting behavioral data from a statistically significant number of individuals; generating a plurality of stereotype behavior profiles from the behavioral data; and selecting one of the stereotype behavior profiles that best represents the user's behavior preferences, the selected stereotype behavior profile operating as the user's initial personal behavior profile.

Another aspect of the present invention involves a profile initializer for a behavior recommender. The profile initializer comprises a behavior database for storing behavioral data of a statistically significant number of individuals; and a stereotype profiler for building a selection of stereotype behavior profiles based on the behavioral data, the stereotype behavior profiles being offered to a user of the recommender for initializing the user's personal behavior profile.

A further aspect of the present invention involves an adaptive behavior recommender. The recommender comprises a behavior database for storing behavioral data of a statistically significant number of individuals; a stereotype profiler for building a selection of stereotype behavior profiles based on the behavioral data; and a recommender for making behavior recommendations based on a user's selected stereotype behavior profile.

### BRIEF DESCRIPTION OF THE DRAWINGS

The advantages, nature, and various additional features of the invention will appear more fully upon consideration of the illustrative embodiments now to be described in detail in connection with accompanying drawings where like numerals are used to identify like elements and wherein:

FIG. 1 is a block diagram illustrating the primary components of a personal television viewer profile initializer according to an exemplary embodiment of the present invention;

FIG. 2 is a data structure which may be used in the present invention for storing the data in the database;

FIG. 3 is a rating scale that may be used for viewer stereotype assessments;

FIG. 4 is a block diagram illustrating an exemplary embodiment of an adaptive television recommender which utilizes the television viewer profile initializer of the present invention; and

FIG. 5 is a block diagram illustrating an exemplary embodiment of hardware for implementing a television recommender that utilizes the television viewer profile initializer of the present invention.

### DETAILED DESCRIPTION OF THE INVENTION

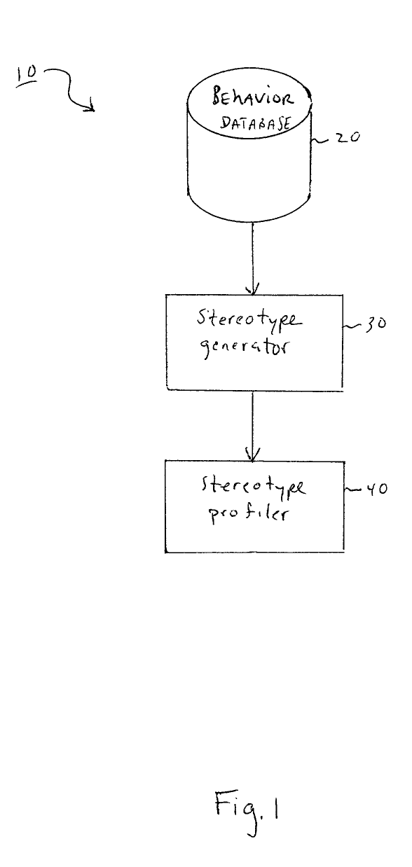

FIG. 1 illustrates the primary components of a personal television (TV) viewer profile initializer 10 according to an exemplary embodiment of the present invention. The profile initializer 10 generates a plurality of stereotype TV viewing profiles, one or more of which may be selected by a viewer to initialize the viewer's personal implicit-based TV viewing profile. The initialized TV viewing profile can then be used by a TV recommender to reduce the time it takes for the recommender to produce accurate TV recommendations. The primary components of the profile initializer 10 include a TV viewing behavior database 20, a stereotype generator 30, and a stereotype TV viewer profiler 40. These components are preferably implemented as software and data that is readable by a data processing device such as a CPU.

The TV viewing behavior database 20 stores the TV viewing behavior of a statistically significant number of TV viewers. The stereotype generator 30 uses the TV viewing behavior data stored in the database 20 to generate a plurality of stereotypes. The stereotype TV viewer profiler 40 uses the pseudo TV viewing behaviors defined by the stereotypes to create a selection of stereotype TV viewer profiles which may be offered to new TV viewers to initialize their own personal TV viewer profile. After initialization (initialization involves the selection of one or more of the stereotype TV viewer profiles as a starting personal TV viewer profile), the personal TV viewer profile may be tailored into a more accurate profile of the viewer using the viewer's own TV viewing behavior.

The exact number of TV viewers contained in the TV viewing behavior database 20 should be large enough to represent the population of the viewers who are expected to employ the stereotypes resulting therefrom. For example, hundreds or thousands of TV viewers may be contained in this data. The TV viewing history duration of these TV viewers should be long enough to include a generous sample of all important types of TV shows, for example, one or more years, so that all significant seasonal variations are present in the data set.

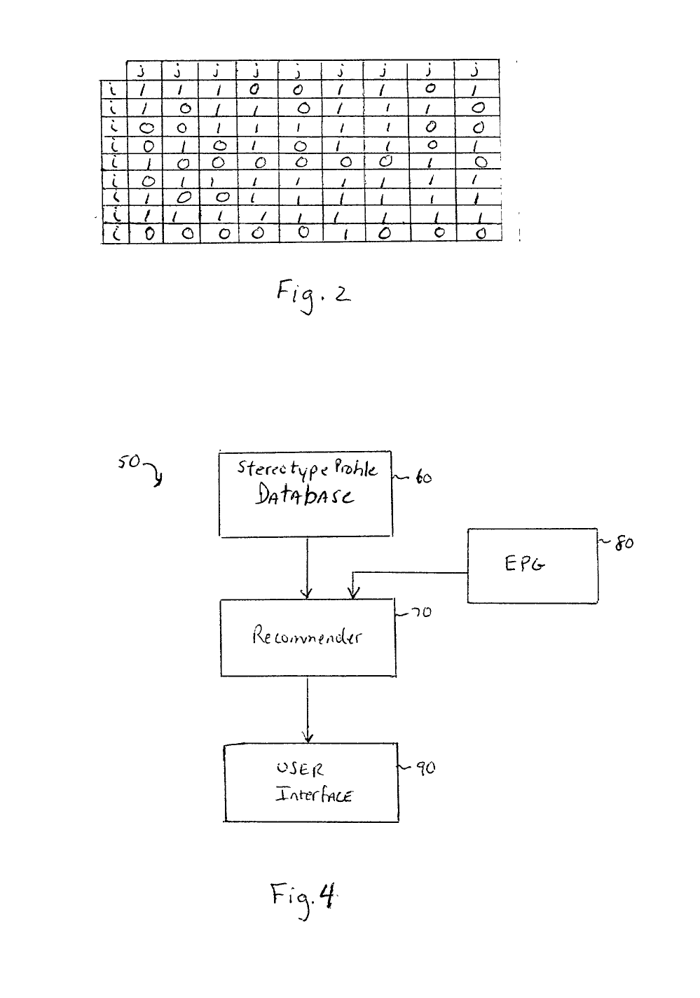

As illustrated in FIG. 2, the data stored in the database 20 may be coded as a binary matrix with a row for each TV viewer and a column for each TV show in the union of all shows for all viewers. A one (1) in row i, column j means that viewer i viewed show j and a zero means that show j was not viewed by viewer i. Accordingly, the stereotypes to be derived will be based only on the viewing/not-viewing of TV shows.

The stereotype generator 30 uses the coded TV viewing behavior data stored in the database to generate a plurality of stereotypes. This may be accomplished by dividing the coded data according to intrinsic classes present in the data, wherein each class defines a stereotype. Division of the data may be accomplished by applying any conventional clustering method to the data. For example, see Michale R. Anderberg, Cluster Analysis for Applications, Academic Press, 1973, or Demiriz, Bennet, Embrechts, Semi-Supervised Clustering Using Genetic Algorithms, Intelligent Engineering Systems Through Artificial Neural Networks Volume 9 (ANNIE99), ASME Press, 1999, p. 809-814.

Clustering of the coded TV viewing behavior data yields clusters which are the stereotypes. For each cluster, the cluster center may be computed as a vector of real numbers in the range [0, 1] that indicates the fraction of the cluster members (TV viewers) who viewed each show.

The stereotype TV viewer profiler 40 creates stereotype TV viewer profiles from the pseudo TV viewing history that comes from each of the stereotypes. Thus, the profiles are derived from TV show features. The stereotype TV viewer profiler accomplishes this using either fixed or variable methods. Fixed methods typically utilize a fixed threshold for including TV shows from the cluster that defined the stereotype. More specifically, TV shows with cluster center vector values close to 1.0 are TV shows that are preferred by the stereotypic TV viewer in the pseudo view history and TV shows with cluster center vector values close to 0.0 are TV shows that are not preferred by the stereotypic viewer in the pseudo view history. For example, if the fixed threshold is set at 0.2, any TV show in the stereotype having a cluster center vector value of greater than 0.7 (0.5+0.2) will be included as a positive example in the pseudo view history and any TV show having a cluster center vector value less than 0.3 (0.5−0.2) will be included as a negative example in the pseudo view history. All TV shows between 0.3 and 0.7 are discarded. Once a pseudo view history is constructed, a stereotype TV viewer profile may be constructed using any conventional probabilistic calculation method, such as Bayesian classifiers or decision trees. For Bayesian methods, see co-pending U.S. patent application Ser. No. 09/498,271 filed on Feb. 4, 2000 entitled Adaptive TV Program Recommender, and for decision tree methods see co-pending U.S. patent application Ser. No. 09/466,406, filed on Dec. 17, 1999, entitled, “Method and Apparatus for Recommending Television Programming Using Decision Trees.” The disclosures of both of these applications are incorporated herein by reference.

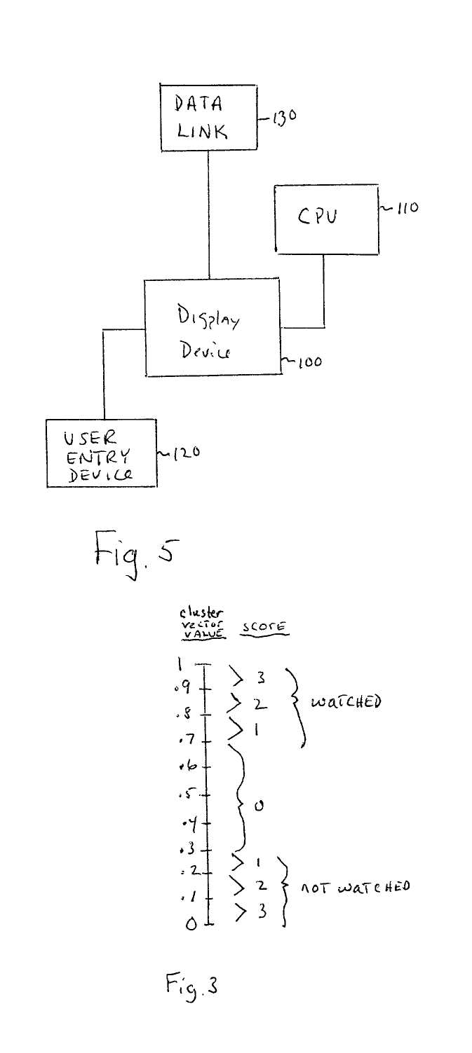

Variable methods involve weighting the features of TV shows in proportion to their cluster center vector values rather than including them (in the viewed or not-viewed portions of the pseudo viewing histories) or excluding them. FIG. 3 shows an example of such a weighting scheme wherein TV shows viewed by more than 90 percent of the viewers in the stereotype cluster are added to the watched portion of the viewing history 3 times, TV shows viewed by 80-89 percent of the cluster viewers are added to the watched portion of the viewing history 2 times, and TV shows viewed by 70-79 percent of the cluster viewers are added to the watched portion of the viewing history 1 time. Similarly, TV shows viewed by less than 10 percent of the cluster viewers would be added to the not-watched portion of the viewing history 3 times, TV shows viewed by 10-19 percent of the cluster viewers are added 2 times to the not-watched portion of the viewing history, and TV shows viewed by 20-29 percent of the cluster viewers are added 1 time to the not-watched portion of the viewing history. Under this illustrative scheme, all shows viewed by 31-69 percent of the cluster viewers would not be included in the pseudo viewing history as they would be deemed to carry no meaningful association with the typical viewing/not-viewing behavior of the stereotype.

The above methods can also be used to allow a viewer to create a composite stereotype profile by combining several stereotype profiles. For example, if there are four stereotype profiles: a) sports-fan; b) comedy-fan; c) high-brow; d) children, a viewer can be provided with a certain number of points, e.g., 10, to distribute among the stereotype profiles in any desired manner. One viewer may distribute 6 points to stereotype profile a and 4 points to stereotype profile b. Another viewer may distribute all 10 points to stereotype profile d. In any case, the composite stereotype profile may be generated by multiplying the positive and negative counts of each feature in the selected stereotype profile by the number of points assigned thereto and combining the counts. The resulting counts can then be normalized (reduced) by dividing through by some desired number since all the counts have been inflated by the points. The number used for normalizing is selected according to how quickly the viewer wants the intialized profile (the composite stereotype profile) to personalize versus how stereotypical the viewer wants his or her initialized profile to be. If the normalization is selected to provide an initialized profile that will personalize quickly, the initialized profile will be less stereotypical (contain very few TV shows). If the normalization is selected to provide an initialized profile that is very stereotypical (contains a large number of TV shows), the initialized profile will take longer to personalize.

Conventional probabilistic calculation methods (Bayesian or decision tree) may be used in the present invention for tailoring the initialized personal TV viewer profile into a more accurate profile of the viewer using the viewer's own TV viewing behavior. Such methods are identical to those used for adapting any profile based on real TV viewing histories, feedback assessments and/or explicit profiles. For example, a TV recommender can apply the Bayesian methods described in the earlier in co-pending U.S. patent application Ser. No. 09/498,271 to the initialized TV viewer profile so that each new viewed (or not viewed) TV show can add its features to the initialized TV viewer profile or increment the counts for features already in the profile. Over time, the conditional probabilities based on these counts will come to reflect the viewer's own individual preferences where they differ from the stereotype.

FIG. 4 illustrates an exemplary embodiment of an adaptive TV recommender 50 which may utilize initialized personal TV viewer profiles generated by the TV viewer profile initializer of the present invention. The TV recommender 50 includes a database 60 which contains a plurality of stereotype profiles generated by the TV viewer profile initializer of the present invention, an adaptive TV recommender 70, a television programming or electronic program guide (EPG) data structure 80, and a user interface 90. Like the profile initializer, the recommender 70 and the EPG 80 are preferably implemented respectively as software and data that is readable by a data processing device such as a CPU. The user interface 90 may be implemented as a PC or a display screen.

The stereotype profiles database 60 serves as an input to the recommender 70. The recommender 70 also uses, as input, the EPG data structure 80 that contains features describing each TV show such as title, channel, start time and the like. The recommender 70 processes initialized personal TV viewer profiles (stereotype profiles selected from the database 60 by viewers) and data from the EPG 80 and displays TV show recommendations on the user interface 90 where viewers can interact with it.

FIG. 5 illustrates an exemplary embodiment of hardware for implementing the TV recommender of FIG. 4. The hardware typically includes a display device 100, a CPU 110, a user entry device 120, and a data link 130. The display device 100 commonly includes a television screen or another other suitable display device. The CPU 110 may be a set top box, a PC, or any other type of data processing device sufficient for running the profile initializer and the recommender. The user entry device 120 may be a keyboard and mouse arrangement or touch sensitivity means associated with the display device 100. The data link 130 may be an antenna, cable TV, a phone line to the internet, a network connection or the like.

Although the present invention has been described in terms of TV viewing behaviors and recommendations for TV shows, the principles of the present invention are not limited to this domain. For example, the principles of the present invention may also be applied to movies, books, audio recordings and the like.

While the foregoing invention has been described with reference to the above embodiments, various modifications and changes can be made without departing from the spirit of the invention. Accordingly, all such modifications and changes are considered to be within the scope of the appended claims.

What is claimed is:

1. A method of initializing a recommender user's personal behavior profile, the method comprising the steps of:
collecting behavioral data from a statistically significant number of individuals, the behavioral data being in the same domain as the recommender user's personal behavior profile will be;
generating a plurality of stereotype behavior profiles from the behavioral data; and
selecting one of the stereotype behavior profiles that best represents the user's behavior preferences, the selected stereotype behavior profile operating as the user's initial personal behavior profile.

2. The method according to claim 1, wherein the step of generating a plurality of stereotype behavior profiles includes dividing the data according to intrinsic classes present in the data, the intrinsic classes defining the plurality of stereotypes.

3. The method according to claim 2, wherein the data is divided into the intrinsic classes by clustering the behavioral data.

4. The method according to claim 2, wherein the step of generating a plurality of stereotype behavior profiles further includes the step of deriving a stereotype behavior profile from a pseudo behavior history defined the data in each corresponding stereotype.

5. The method according to claim 4, wherein the pseudo behavior history is generated by applying a fixed threshold to the data in each of the classes, the fixed threshold including behavior from the class that defined the stereotype.

6. The method according to claim 5, wherein the step of generating a plurality of stereotype behavior profiles further includes the step of constructing a stereotype behavior profile from each pseudo behavior history.

7. The method according to claim 6, wherein the constructing step is performed with Bayesian classifiers.

8. The method according to claim 6, wherein the constructing step is performed with decision trees.

9. The method according to claim 4, wherein the pseudo behavior history is generated by scoring in proportion to representation in the class and adding a predetermined number of copies the behavior from the class that defined the stereotype to the pseudo view history.

10. The method according to claim 9, wherein the step of generating a plurality of stereotype behavior profiles further Includes the step of constructing a stereotype behavior profile from each pseudo behavior history.

11. The method according to claim 10, wherein the constructing step is performed with Bayesian classifiers.

12. The method according to claim 10, wherein the constructing step is performed with decision trees.

13. The method according to claim 1, wherein the stereotype behavior profiles are built from the behavior and non-behavior of the individuals.

14. The method according to claim 1, further comprising the step of tailoring the selected stereotype behavior profile into a more accurate profile of the user's own behavior using the user's own behavior.

15. The method according to claim 1, wherein the behavior is in the domain of television viewing.

16. The method according to claim 1, wherein the behavior is in the domain of multimedia viewing.

17. A profile initializer for a behavior recommender, the profile initializer comprising:
a behavior database for storing behavioral data of a statistically significant number of individuals; and
a stereotype profiler for building a selection of stereotype behavior profiles from the behavioral data, the stereotype behavior profiles for offering to a user of the recommender to initialize the user's personal behavior profile.

18. The profile initializer according to claim 17, further comprising a stereotype generator for generating behavior stereotypes from the behavioral data stored in the behavior database, wherein the stereotype profiler uses pseudo behavior histories obtained from the behavior stereotypes for building the stereotype behavior profiles.

19. The profile initializer according to claim 17, wherein the behavior is in the domain of television viewing.

20. The profile initializer according to claim 17, wherein the behavior is in the domain of multimedia viewing.

21. An adaptive behavior recommender comprising:
a behavior database for storing behavioral data of a statistically significant number of individuals;
a stereotype profiler for building a selection of stereotype behavior profiles from the behavioral data, the stereotype behavior profiles being offered to a user of the recommender for initializing the user's personal behavior profile; and
a recommender for making behavior recommendations based on the user's selected stereotype behavior profile.

22. The behavior recommender according to claim 21, further comprising a user interface for displaying the behavior recommendations.

23. The behavior recommender according to claim 21, further comprising a stereotype generator for generating behavior stereotypes from the behavioral data stored in the behavior database, wherein the stereotype profiler uses pseudo behavior histories obtained from the behavior stereotypes for building the stereotype behavior profiles.

24. The behavior recommender according to claim 21, further comprising a personal profiler for tailoring the user selected stereotype behavior profile into a personal profile of the user's behavior using the actual behavior of the user.

25. The behavior recommender according to claim 21, wherein the behavior is in the domain of television viewing.

26. The behavior recommender according to claim 21, wherein the behavior is in the domain of multimedia viewing.
